(19) United States
(12) Patent Application Publication
(10) Pub. No.: US 2009/0012661 A1
(43) Pub. Date: Jan. 8, 2009

(54) DEVICE AND METHOD FOR CHANGING THE ZONES PROHIBITED TO AN AIRCRAFT

(75) Inventor: Xavier Louis, Goyrans (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/095,851

(22) PCT Filed: Nov. 29, 2006
(86) PCT No.: PCT/EP2006/069034

§ 371 Date: Sep. 11, 2008

(30) Foreign Application Priority Data
Dec. 2, 2005 (FR) 05/12259

(51) Int. Cl. G05D 1/10

(52) U.S. Cl. 701/9

(57) ABSTRACT

The present invention relates to a device and method for changing the zones prohibited to an aircraft. The method comprises a phase of defining the geometry of the restricted-access zones and their access conditions which depend on the aircraft, a phase of characterizing the aircraft with respect to the access conditions for the zones and a phase of determining the zones to which the aircraft has no access.

### CROSS-REFERENCE TO RELATED APPLICATIONS

The present Application is based on International Application No. PCT/EP2006/069034, filed on Nov. 29, 2006, which in turn corresponds to French Application No. 0512259 filed on Dec. 2, 2005, and priority is hereby claimed under 35 USC §119 based on these applications. Each of these applications are hereby incorporated by reference in their entirety into the present application.

### FIELD OF THE INVENTION

The present invention relates to a device and a method for changing the zones prohibited to an aircraft. It applies in the field of aeronautics. For example, within the framework of avionics and embedded systems, it applies to systems intended to avoid the planet, such as systems known as “Terrain Awareness and Warning Systems”, which will be called TAWS systems subsequently.

### BACKGROUND OF THE INVENTION

TAWS systems and planet avoidance systems in general are systems embedded on board aircraft which are aimed at alleviating any control or piloting errors that could cause an aircraft to collide with the ground or with what is commonly referred to in aeronautics by the expression “Man Made Structures”, which will be called MMSs subsequently. MMSs are human constructions on the ground constituting a potential obstacle to air traffic on account of their scale, notably when the airplanes are in the phase of takeoff or descent to an aerodrome. Among these obstacles may be cited for example radio-broadcasting antennas, high-voltage lines or skyscrapers.

It is essentially the air traffic control which ensures compliance with safety distances between aircraft and the ground and which signals the MMSs, even if the crew also have paper or digitized maps providing them with information about approach or takeoff procedures and threats, MMSs or the like, that they may encounter. The approach controller gives climb or descent instructions to the pilot by radio, who executes the instructions in a completely assisted manner. But the execution of these instructions is entirely subject to the will or to the availability of the pilot. In the case where the pilot is no longer able to receive or to execute the controller's instructions, if hijacked for example, there is no onboard system that can substitute for the controller and for the pilot. Indeed, even if onboard instruments make it possible to measure the altitude of the craft with greater or lesser precision, by being based on a pressure measurement and the application of a gradient from a reference pressure, accurately knowing the distance to the ground is much more complex. This requires notably that detailed knowledge be available of the relief, the human infrastructures on the surface, and that they can be utilized rapidly in view of the enormous quantity of information that this represents. This is the role of the increasingly widespread planet avoidance systems, such as TAWS systems.

For example, current TAWS systems have a connection to a triangulation-based positioning system of the “Global Positioning System” type for example, or a connection with radio-navigation equipment on the ground and on board enabling them to ascertain their position in three dimensions. They deduce therefrom their position in latitude and longitude as well as their altitude relative to sea level. They also have a digital terrain model supplied by a terrain database making it possible, for any position in space characterized by a latitude and a longitude, to ascertain the altitude of the relief relative to sea level. By comparing the altitude of the aircraft with the altitude of the relief, these systems deduce the distance of the aircraft with respect to the ground, inform the flight personnel thereof and possibly raise audible or visual alerts in cases of imminent risk of collision with the ground. These systems also comprise a means for storing the MMSs, which are described by their position in latitude and longitude, by their altitude relative to sea level consistent with the embedded digital terrain model and finally by their height. Each MMS is associated with a radius and with an uncertainty sometimes expressed in kilometers, these two parameters being presumed to convey the lack of precision as regards the location and scale of the obstacle. Such a representation of the obstacles is only suited to pointlike obstacles, such as an antenna, pylon or isolated tower, but absolutely not to voluminal obstacles, like collections of skyscrapers, except by introducing very significant safety distances by increasing the radius and uncertainty so as to encompass these obstacles.

Now, current requirements are tending to precision in the definition of obstacles, going as far as to demand that it be possible to take account of separate but closely spaced voluminal obstacles of large scale and that the safety distance be adapted in certain situations. For example, any airliner traffic may be barred from overflying and approaching a concentration of skyscrapers at a significant distance. But light aircraft flight may be authorized at medium distance. Helicopters may be authorized to put down on infrastructures in direct proximity to skyscrapers, they must consequently be able to approach at very close distance. For example again, certain equipment which develops a fault may render a craft less reliable or less secure. Barring it proximity to certain obstacles, the approach to which would require the use of faulty equipment, is a measure which is directed towards flight safety. For example again, it is preferable to prevent a hijacked airplane from approaching MMSs with large population concentration such as skyscrapers.

Current TAWS systems and the way of modeling the MMSs that they implement do not allow such a level of precision and flexibility. Thus, obstacles of fairly small scale generate an extensive flight sector that is barred to all. Aircraft not exhibiting any counter-indication to the approach to certain obstacles have their approach definitively barred or conversely aircraft whose approach to an obstacle exhibits a real danger are allowed to overfly freely.

### SUMMARY OF THE INVENTION

The aim of the invention is notably to offer a generic solution to the problems of anti-collision with all types of obstacles on the ground, whatever their dimensions. For this purpose, the subject of the invention is a method for changing the zones prohibited to an aircraft. It comprises a phase of defining the geometry of the restricted-access zones and their access conditions which depend on the aircraft, a phase of characterizing the aircraft with respect to the access conditions for the zones and a phase of determining the zones to which the aircraft has no access.

Advantageously, access to the zones can be conditioned by the type of aircraft or its operational flight situation.

The subject of the invention is also a system for changing the zones prohibited to an aircraft. It comprises a means for storing the restricted-access zones described by their geometry and their access conditions which depend on the aircraft, a module for characterizing the aircraft with respect to the access conditions for the zones and a module for determining the zones to which the aircraft has no access.

Advantageously, access to the zones can be conditioned by the type of aircraft or its operational flight situation.

The prohibited zones can be provided to a flight system raising an audible or visual alert when a prohibited zone will be penetrated or to an automatic piloting system rendering penetration of these zones by the aircraft impossible.

The main advantages of the invention are further that it offers a great deal of flexibility since it is adaptable to all types of aircraft, making it possible for example to nest zones of protection of an obstacle as a function of the type of aircraft to which they are addressed. This flexibility makes the invention an excellent basis for the definition of a new standard of zones that can be shared by the whole aeronautical community, be it civil, military, commercial or leisure, and greatly exceeding the framework of the protection of ground obstacles. It allows dynamic updating of the zones prohibited to an aircraft as a function of the evolution of its operational situation throughout the flight, thus completely breaking with the fixed nature of the former zones. Moreover, it is easy to implement on existing embedded systems. In future, it will even make it possible to utilize a function currently under study and which will be very tricky to use, consisting in taking over control from the pilot in certain exceptional critical situations. Finally, protecting voluminal obstacles on the ground by zones whose geometry is described in three dimensions is a simple way of taking account of the reliefs of the terrain.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, as a schematic, the successive phases of the method according to the invention;

FIG. 2, as a schematic, an exemplary TAWS system architecture implementing the method according to the invention.

### DETAILED DESCRIPTION OF THE INVENTION

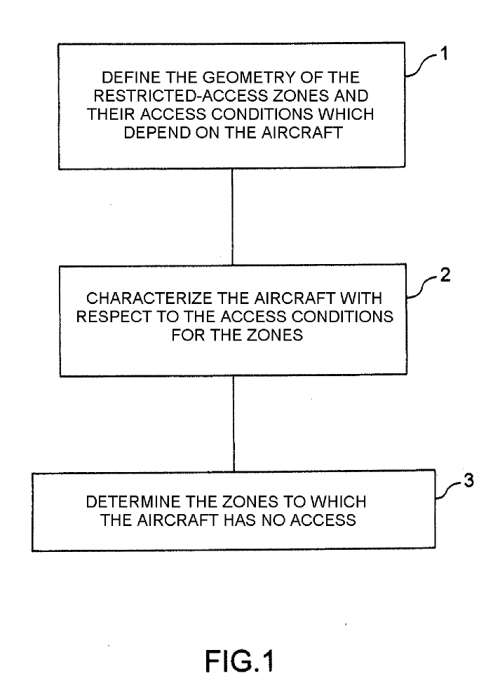

FIG. 1 illustrates as a schematic the possible phases of the method according to the invention.

To begin with it comprises a first phase 1 of defining the geometry of the restricted-access zones and their access conditions which depend on the aircraft. Initially this involves describing airspace portions, each in the form of a list of points by latitude, longitude and height above the relief. The list of points by latitude and longitude determines a two-dimensional polygon, the height above the relief determines a three-dimensional zone, whose base is the previously defined polygon, a sheet-like zone of variable thickness above the relief. Subsequently it involves establishing criteria which the aircraft will have to satisfy so as to be authorized to penetrate the zones. Advantageously, it may be envisaged that only certain types of aircraft are given access to a zone, as a function of their performance and their maneuvrability for example. It may be envisaged that access to a zone be authorized only to aircraft not exhibiting any safety equipment fault or failure symptom. It may be envisaged further that access to a zone be authorized only to aircraft that have given no sign intimating that the flight might be the subject of a hijack, for example that have never sent the “hijacked” code with their transponder during the flight.

This way of describing zones with regulated access affords notably great flexibility. Indeed it makes it possible to nest them one inside another and thus to adapt the safety distance to the type of aircraft. For example, a collection of skyscrapers may be encompassed in a first zone accessible to no aircraft, whatever its type. This zone prohibited to any aircraft may itself be encompassed in a second more extensive zone accessible solely to helicopters. This zone accessible to helicopters may itself be encompassed in a third still more extensive zone accessible solely to helicopters and to light aircraft.

Thus, airliners are barred from access to the third zone, at a large distance from the skyscrapers, it being possible for this zone to be penetrated only by light aircraft and helicopters. Then, light aircraft are barred from access to the second zone, at a medium distance from the skyscrapers, it being possible for this zone to be penetrated only by helicopters. Finally, helicopters are barred from access to the first zone, in immediate proximity to the skyscrapers, it not being possible for this zone to be penetrated by any aircraft.

The method according to the invention also comprises a phase 2 of characterizing the aircraft with respect to the access conditions for the zones. It involves, for each of the criteria which an aircraft must satisfy so as to be authorized to penetrate a zone, determining the state of the aircraft in relation to this criterion. Advantageously, this can entail the onboard personnel declaring any particular operational situation, such as declaring fault reports or setting their transponder to the “hijacked” code as soon as they suspect an imminent hijack. Or else this can entail the ground control personnel designating any airplane behaving suspiciously viewed from the ground, radio silence for example, the ground systems then dispatching this suspicion information to the embedded systems through an existing RF data link. All this introduces a genuine dynamic. Specifically, returning to the previous example of the three nested zones, a fourth zone may be envisaged, encompassing the third zone still more widely and which is accessible only to aircraft not exhibiting any fault symptom nor exhibiting any possible hijack sign. Thus, an aircraft which normally can approach skyscrapers as far as the third zone, the second zone, or even the first zone depending on its type, may during flight be dynamically assigned a much larger safety distance with respect to the skyscrapers, following a fault report or a suspicion of hijack.

The method according to the invention finally comprises a phase 3 of determining the zones to which the aircraft has no access. This involves, upon characterizing an aircraft with respect to the access conditions for the zones, updating the aircraft's authorizations to access each of the zones. In the extreme case of a hijack, it may be contemplated that the airspace be split up into restricted zones so as no longer to authorize a hijacked flight except in very particular zones, for example already existing military zones. Specifically, military zones exhibit a very low population density and almost zero air traffic outside of military maneuvers. They therefore exhibit all the safety conditions required to manage this kind of situation as calmly as possible. And, in parallel with this, non-military zones become barred to hijacked flights. In this case it is also desirable to couple the planet avoidance system, be it a TAWS or other system, to the automatic piloting system so that it takes over authority from the pilot, which will very shortly be possible. By being based on the new zones barred or authorized to hijacked airplanes, the automatic piloting system can easily prevent the airplane from entering the prohibited zones protecting human infrastructures and steer the airplane towards a secure military zone. But it is also possible to envisage other situations in which the automatic piloting system takes over authority from the pilot based on the restricted zones according to the invention. For example, returning again to the example of the three zones encompassing the collection of buildings, automatic piloting would be able to prevent the airplane from overriding the bar or penetrating the third zone. In this case, before control is taken of the craft, there may be an alert followed by a notification to the pilot by the “Flight Warning Computer”, which will subsequently be called the FWC, which is a system dedicated to raising alerts. Indeed, hijackers well acquainted with control procedures would be able to seize hold of a craft without any exterior sign thereof being given. Thus, even if they are not steered immediately towards a secure military zone, at least they cannot approach human infrastructures with large population density. It thus becomes technically impossible to approach potential targets to a terrorist attack with an aircraft whose size renders it capable of causing significant damage if it were used as a projectile.

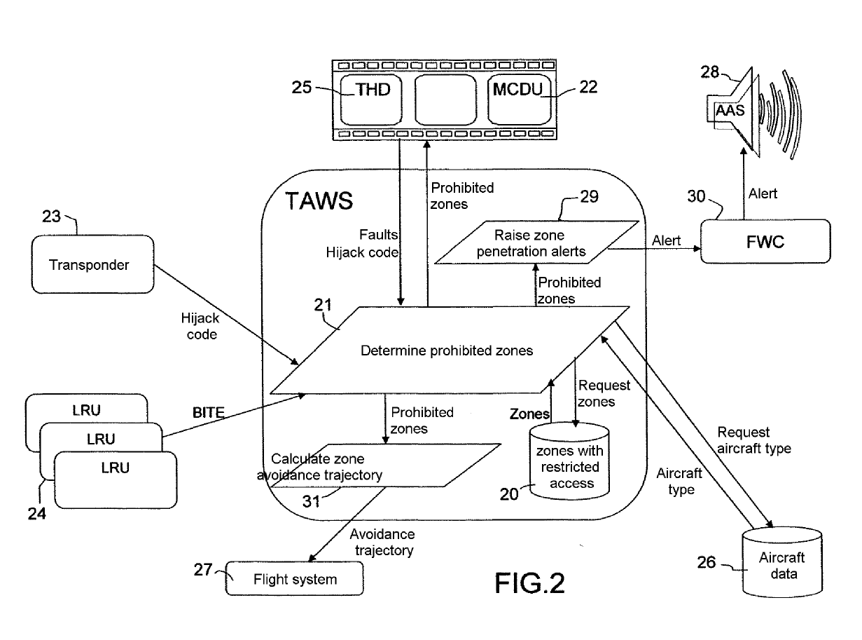

FIG. 2 illustrates as a schematic an exemplary TAWS system architecture implementing the method according to the invention.

It comprises a database 20 of the restricted-access zones which describes each zone in terms of geographical situation in latitudes, longitudes and height above the terrain, and in terms of aircraft-dependent access conditions. Ideally, the description of these zones can follow a standard recognized by the various aeronautical parties, whether civil or military. Ideally also, approved distributors can provide up-to-date versions of these standardized zone databases, as a function of MMS constructions and demolitions.

The exemplary TAWS system according to the invention also comprises a function 21 for determining the prohibited zones. This function first of all asks, on takeoff for example, the database 20 for zones, so as to have the generic division of the airspace into restricted zones. Then on the basis of the aircraft-specific data known by a database 26 for example, advantageously the type of aircraft, this function 21 determines a first list of zones barred to the aircraft in particular and into which the latter is not authorized to penetrate, right from takeoff. Then, each time that it receives a message that might modify this list, the function 21 reconsiders the zones prohibited to the aircraft, taking account of the new situation. Advantageously, it can receive any message indicating an exceptional operational situation. For example, this can be a fault report of the “Built-in Test Equipment” type, which will be called a BITE report subsequently, sent by a “Line Replaceable Unit” 24 ensuring a safety function, which will be called an LRU subsequently. The LRUs are hardware and software plug-in modules such as computers, sensors or actuators, that can be easily replaced if necessary. They comprise a maintenance function of a type known by the designation BITE function. This BITE function allows the LRUs to carry out diagnostics on their internal operating state and to send reports that by extension are called BITE reports. For example again, the function 21 can receive fault reports entered manually on a “Multi purpose Control Display Unit” 22, which will be called an MCDU subsequently. An MCDU is an integrated screen and keyboard device that is fairly widespread in avionics. Its main characteristic is that of offering very generic services of display and input of alphanumeric characters. Thus it is easily adaptable to various new applications and notably to the implementation of the invention, for example the entering of fault reports when the latter do not form the subject of an automatic diagnostic of the BITE report type sent by an LRU. For example finally the function 21 can receive all the codes dispatched by the transponder 23 or some other equipment, so as to spot the possible sending of the “hijacked” code, even if it is very brief. All these messages convey an event that might modify the zones barred specifically to the aircraft.

The function 21 dispatches for example the prohibited zones to a display module of the type of a “Terrain Hazard Display” 25, which is an avionics standard graphical display device offering functions for viewing zones in two dimensions. Thus the pilot is informed graphically and in real time of the zones that he must avoid. Advantageously, the function 21 also dispatches the prohibited zones to another sub-function 29 of the TAWS which, permanently knowing the position of the craft, is able to raise audible alerts when a barred zone is about to be penetrated by virtue of an FWC 30 and an “Aircraft Audio system” 28, which is an avionics standard sound emission device. Advantageously here again, the function 21 dispatches the prohibited zones to another sub-function 31 of the TAWS which, also permanently knowing the position of the craft, proposes avoidance trajectories when a barred zone is penetrated. It dispatches the avoidance trajectories to a flight system 27 which may for example have an automatic pilot function. The automatic pilot function can, under certain extreme conditions and when the zones authorized to the aircraft are limited to military zones for example, take over authority from the pilot so as to steer the craft into one of the zones in question.

The above-described exemplary embodiment of a device comes within the framework of a TAWS system. But it should be clearly understood that any planet avoidance system can deploy the method according to the invention.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for dynamically updating zones prohibited to an aircraft, the method comprising:
a phase of recovering the geometry of the restricted-access zones and their access conditions which depend on the aircraft;
a phase of characterizing the status with respect to the access conditions for the zones;
a phase of determining the zones to which the aircraft has no access;
the phase of characterizing the status of the aircraft and the phase of determining the zones to which the aircraft has no access being triggered as soon as an event is likely to modify the status of the aircraft in relation to the access conditions for a zone.

2. The method for dynamically updating the zones prohibited to an aircraft as claimed in claim 1, wherein access to the zones is conditioned by the type of aircraft.

3. The method for dynamically updating the zones prohibited to an aircraft as claimed in claim 1, wherein access to the zones is conditioned by the performance or the maneuvrability of the aircraft.

4. The method for dynamically updating the zones prohibited to an aircraft as claimed in claim 1, wherein access to the zones is conditioned by the operational flight situation of the aircraft.

5. The method for dynamically updating the zones prohibited to an aircraft as claimed in claim 1, wherein access to the zones is conditioned by the sending with the transponder of the hijack code.

6. The method for dynamically updating the zones prohibited to an aircraft as claimed in claim 1, wherein obstacles on the ground are encompassed in a first zone accessible to no aircraft, the first zone itself being encompassed in a second zone accessible solely to helicopters, the second zone itself being encompassed in a third zone accessible solely to light aircraft, the third zone itself being encompassed in a fourth zone accessible solely to airplanes not exhibiting any fault or hijack symptom.

7. A system for dynamically updating the zones prohibited to an aircraft, the system comprising:
a means for storing the restricted-access zones described by their geometry and their access conditions which depend on the aircraft;
a module for characterizing the status of the aircraft with respect to the access conditions for the zones;
a module for determining the zones to which the aircraft has no access;
the module for characterizing the status of the aircraft and the module for determining the zones to which the aircraft has no access being activated as soon as an event is likely to modify the status of the aircraft in relation to the access conditions for a zone.

8. The system for dynamically updating the zones prohibited to an aircraft as claimed in claim 7, wherein access to the zones is conditioned by the type of aircraft.

9. The system for dynamically updating the zones prohibited to an aircraft as claimed in claim 7, wherein access to the zones is conditioned by the performance or the maneuvrability of the aircraft.

10. The system for dynamically updating the zones prohibited to an aircraft as claimed in claim 7, wherein access to the zones is conditioned by the operational flight situation of the aircraft.

11. The system for dynamically updating the zones prohibited to an aircraft as claimed in claim 7, wherein a flight system raises an audible or visual alert when a prohibited zone is penetrated.

12. The system for dynamically updating the zones prohibited to an aircraft as claimed in claim 7, wherein a flight system prevents the penetration of a prohibited zone by taking control of the aircraft.
